(19) United States
(12) Patent Application Publication
(10) Pub. No.: US 2016/0195922 A1
(43) Pub. Date: Jul. 7, 2016

(54) WEARABLE APPARATUS, DISPLAY METHOD THEREOF, AND CONTROL METHOD THEREOF

(71) Applicants: Kinpo Electronics, Inc., New Taipei City (TW); Cal-Comp Electronics & Communications Company Limited, New Taipei City (TW)

(72) Inventors: Wen-Hsin Lo, New Taipei City (TW); Chia-Chin Tsai, New Taipei City (TW)

(21) Appl. No.: 14/687,929

(22) Filed: Apr. 16, 2015

(30) Foreign Application Priority Data
Jan. 5, 2015 (TW) 104100058

(51) Int. Cl. G06F 3/01; H04N 5/232; G06F 3/041; G06F 1/16; G06F 3/00

(52) U.S. Cl. CPC G06F 3/011; G06F 1/163; G06F 3/002; G06F 3/015; G06F 3/0412; G06F 3/0416; H04N 5/23216; H04N 5/23296; G06F 2203/04102

(57) ABSTRACT

A wearable apparatus, a display method thereof, and a control method thereof are provided. The wearable apparatus includes a ring body. The moving status of the wearable apparatus is detected by a G-sensor in the ring body. Auxiliary sensors of the wearable apparatus are arranged and disposed on a first surface of the ring body facing a human body. A flexible screen of the wearable apparatus is disposed in a surrounding manner on a second surface of the ring body facing away from the human body. When the moving status of the wearable apparatus is determined as a view operation by a processing unit, the relative position between the auxiliary sensors and the human body is detected through the auxiliary sensors. A display block on the flexible screen is decided according to the relative position, and a frame is displayed on the display block of the ring body.

### CROSS-REFERENCE TO RELATED APPLICATION

This application claims the priority benefit of Taiwan application serial no. 104100058, filed on Jan. 5, 2015. The entirety of the above-mentioned patent application is hereby incorporated by reference herein and made a part of this specification.

### BACKGROUND OF THE INVENTION

1. Field of the Invention

The invention relates to an electronic apparatus, and more particularly, to a wearable apparatus, a display method thereof, and a control method thereof.

2. Description of Related Art

As technology advances, portable electronic apparatuses having small size such as smart watches and tablet computers are gradually becoming necessities in everyday life. Moreover, as smartphones and applications thereof become popular, and with the growing attention to physical health, applications related to exercise, fitness, health care, or personal health are continuously developed, such that more manufacturers are driven to invest in the development of wearable products such as smart watches or bracelets.

In general, a portion of commercial smart watches or bracelets are provided with a display to display relevant information such as time, map, position, or heartbeat. However, the display on the wearable apparatuses is generally fixed on the watch band or a specific position on the ring body, and therefore the user needs to adjust the position of the display to readily see the message on the display. For instance, a smart watch needs to be worn on a wrist, and the display needs to be adjusted to a position readily viewed by the user, so that the user can view the information on the display. The traditional wearing methods of a watch not only do not provide a technological feel to the exterior of smart watches or bracelets, but also indirectly limit the aesthetic design of the wearable apparatus. Therefore, a technique that allows the user to view or operate a wearable apparatus more intuitively, rapidly, and conveniently is needed, and it is preferred that the technique can also improve the aesthetics and technological feel of the wearable apparatus.

### SUMMARY OF THE INVENTION

The invention provides a wearable apparatus, a display method, and a control method. The wearable apparatus includes a ring body, and the wearable apparatus can decide the method of screen display to provide a convenient display method and control method having a new look via the moving state of the wearable apparatus and the wearing state of the wearable apparatus on a human body. Moreover, a trigger signal can be generated via the determination of the moving state of the wearable apparatus, so as to provide a signal to control the shooting function or the lens zoom operation of a remote photographic equipment (such as a mobile phone), thus resulting in another added value to the wearable apparatus.

The invention provides a wearable apparatus suitable to be worn on the surface of human skin via physical contact, and the wearable apparatus includes a ring body. The ring body is surrounded with the periphery of the human body, and the ring body includes a G-sensor, auxiliary sensors, a flexible screen, and a processing unit. The G-sensor is used to detect the moving state of the wearable apparatus. The auxiliary sensors are respectively arranged and disposed on a first surface of the ring body facing the human body. The flexible screen is disposed on a second surface of the ring body facing away from the human body in a surrounding manner. The processing unit is coupled to the G-sensor, the auxiliary sensors, and the flexible screen. The processing unit detects the moving state of the wearable apparatus via the G-sensor, when the processing unit determines the moving state of the wearable apparatus as a view operation, the processing unit determines the relative position of each of the auxiliary sensors to the human body via each of the auxiliary sensors, decides a display block on the flexible screen according to the relative position of each of the auxiliary sensors to the human body, and displays a frame on the display block of the ring body.

In an embodiment of the invention, the processing unit decides one of the auxiliary sensors farthest from the human body as a reference sensor according to the relative position of each of the auxiliary sensors to the human body, and decides the display block on the flexible screen according to the position of the reference sensor.

In an embodiment of the invention, the auxiliary sensors include infrared emitters and corresponding infrared receivers. The infrared emitters respectively emit an infrared light, and the infrared receivers respectively receive the infrared light reflected from the human body. The processing unit compares the receive time that each of the infrared receivers receives the infrared light to decide the relative position of each of the auxiliary sensors to the human body. The processing unit decides one of the infrared receivers having the longest receive time as the reference sensor.

In an embodiment of the invention, the auxiliary sensors include light emitters and corresponding light receivers. A ball channel is disposed between the light emitters and the light receivers arranged on the first surface of the ring body, and a ball is disposed on the ball channel. The light emitters respectively emit a light source, the light receivers respectively receive the light source, and the processing unit determines the degree of shielding of the ball sensed by the light receivers to decide the relative position of each of the auxiliary sensors to the human body. The processing unit decides one of the light receivers having the greatest degree of shielding as the reference sensor.

In an embodiment of the invention, the auxiliary sensors include magneto-resistive (MR) sensors. A slide channel is disposed adjacent to the magneto-resistive sensors arranged on the first surface of the ring body, and a magnetic device is disposed on the slide channel. The processing unit compares a magnetic line of force sensed from the magnetic device by the magneto-resistive sensors to decide the relative position of each of the auxiliary sensors to the human body. The processing unit decides one of the magneto-resistive sensors of a preset direction of magnetic line of force as the reference sensor.

In an embodiment of the invention, the auxiliary sensors include capacitive sensors. The processing unit determines the sensing state sensed from the human body by the capacitive sensors to decide the relative position of each of the auxiliary sensors to the human body. The processing unit decides one of the capacitive sensors that does not sense as the reference sensor.

In an embodiment of the invention, the auxiliary sensors include humidity sensors. The processing unit determines the humidity sensed from the human body by the humidity sensors to decide the relative position of each of the auxiliary sensors to the human body. The processing unit decides one of the humidity sensors for which the sensed humidity is less than a preset humidity as the reference sensor.

In an embodiment of the invention, the auxiliary sensors include conductor apparatuses, and each of the conductor apparatuses is bridged with the processing unit via a voltage loop. The processing unit determines the change in impedance of the conductor apparatuses to decide the relative position of each of the auxiliary sensors to the human body. The processing unit decides one of the conductor apparatuses without change in impedance as the reference sensor.

In an embodiment of the invention, the auxiliary sensors include heartbeat sensors, and the processing unit compares ECG signals sensed by the heartbeat sensors to decide the relative position of each of the heartbeat sensors to a determination region of the human body. The processing unit determines one of the heartbeat sensors having the strongest detected ECG signal as the reference sensor to decide the display block on the flexible screen according to the position of the reference sensor.

In an embodiment of the invention, the processing unit decides an angle range of a reference sensor from one of the auxiliary sensors extended along the flexible screen according to the relative position of each of the auxiliary sensors to the human body, and a block for which the angle range corresponds to the flexible screen is used as the display block.

The invention provides a display method of a wearable apparatus suitable for a wearable apparatus having a ring body. The ring body is surrounded with the periphery of the human body. The display method includes the following steps. The moving state of the wearable apparatus is detected via the G-sensor. When the moving state of the wearable apparatus is determined as a view operation, the relative position of each of the auxiliary sensors to the human body is determined via the auxiliary sensors, wherein the auxiliary sensors are respectively arranged and disposed on a first surface of the ring body facing the human body. A display block on the flexible screen of the wearable apparatus is decided according to the relative position of each of the auxiliary sensors to the human body, wherein the flexible screen is disposed on a second surface of the ring body facing away from the human body in a surrounding manner. A frame is displayed on the display block of the ring body.

In an embodiment of the invention, deciding the display block on the flexible screen of the wearable apparatus according to the relative position of each of the auxiliary sensors to the human body includes the following steps. A reference sensor from one of the auxiliary sensors farthest from the human body is decided according to the relative position of each of the auxiliary sensors to the human body. The display block is decided according to the position of the reference sensor.

In an embodiment of the invention, the auxiliary sensors include infrared emitters and corresponding infrared receivers, and the determination of the relative position of each of the auxiliary sensors to the human body via the auxiliary sensors includes the following steps. Infrared light is respectively emitted via the infrared emitters. The infrared light reflected from the human body is respectively received via the infrared receivers. The receive time that each of the infrared receivers receives the infrared light is compared to decide the relative position of each of the auxiliary sensors to the human body. One of the infrared receivers having the longest receive time is decided as the reference sensor.

In an embodiment of the invention, the auxiliary sensors include light emitters and corresponding light receivers, a ball channel is disposed between the light emitters and the light receivers arranged on the first surface of the ring body, a ball is disposed on the ball channel, and the determination of the relative position of each of the auxiliary sensors to the human body via the auxiliary sensors includes the following steps. Light sources are respectively emitted via the light emitters. The light sources are respectively received via the light receivers. The degree of shielding of the ball sensed by the light receivers is determined to decide the relative position of each of the auxiliary sensors to the human body. One of the light receivers having the greatest degree of shielding is decided as the reference sensor.

In an embodiment of the invention, the auxiliary sensors include magneto-resistive sensors, a slide channel is disposed adjacent to the magneto-resistive sensors arranged on the first surface of the ring body, a magnetic device is disposed on the slide channel, and the determination of the relative position of each of the auxiliary sensors to the human body via the auxiliary sensors includes the following steps. A magnetic line of force sensed from the magnetic device by the magneto-resistive sensors is compared to decide the relative position of each of the auxiliary sensors to the human body. One of the magneto-resistive sensors of a preset direction of magnetic line of force is decided as the reference sensor.

In an embodiment of the invention, the auxiliary sensors include capacitive sensors, and the determination of the relative position of each of the auxiliary sensors to the human body via the auxiliary sensors includes the following steps. The sensing state sensed from the human body by the capacitive sensors is determined to decide the relative position of each of the auxiliary sensors to the human body. One of the capacitive sensors that does not sense is decided as the reference sensor.

In an embodiment of the invention, the auxiliary sensors include humidity sensors, and the determination of the relative position of each of the auxiliary sensors to the human body via the auxiliary sensors includes the following steps. The humidity sensed from the human body by the humidity sensors is determined to decide the relative position of each of the auxiliary sensors to the human body. One of the humidity sensors for which the sensed humidity is less than a preset humidity is decided as the reference sensor.

In an embodiment of the invention, the auxiliary sensors include conductor apparatuses, each of the conductor apparatuses is coupled to a voltage loop, and the determination of the relative position of each of the auxiliary sensors to the human body via the auxiliary sensors includes the following steps. The change in impedance of the conductor apparatuses is determined to decide the relative position of each of the auxiliary sensors to the human body. One of the conductor apparatuses without change in impedance is decided as the reference sensor.

In an embodiment of the invention, the auxiliary sensors include heartbeat sensors, and the determination of the relative position of each of the auxiliary sensors to the human body via the auxiliary sensors includes the following steps. The ECG signals detected by the heartbeat sensors are compared to decide the relative position of each of the heartbeat sensors to a determination region of the human body. One of the heartbeat sensors having the strongest detected ECG signal is determined to be the reference sensor.

In an embodiment of the invention, the step of deciding the display block on the flexible screen of the wearable apparatus according to the relative position of each of the auxiliary sensors to the human body includes the following steps. An angle range of a reference sensor from one of the auxiliary sensors extended along the flexible screen is decided according to the relative position of each of the auxiliary sensors to the human body. A block for which the angle range corresponds to the flexible screen is used as the display block.

The invention provides a wearable apparatus. The wearable apparatus includes a ring body, and the ring body surrounds the periphery of the human body. Moreover, the ring body includes a G-sensor, a communication unit, a zoom sensing module, and a processing unit. The G-sensor is used to detect the moving state of the wearable apparatus. The communication unit is used to send and receive a wireless signal. The zoom sensing module is used to detect a zoom operation. The processing unit is coupled to the G-sensor, the zoom sensing module, and the communication unit. The processing unit detects the moving state of the wearable apparatus via the G-sensor. When the processing unit determines the moving state of the wearable apparatus as a shooting operation, the processing unit determines whether a zoom operation is detected via a zoom sensing module so as to decide whether to generate a focus adjustment signal. Moreover, a shooting start signal is sent via the communication unit.

In an embodiment of the invention, the processing unit determines whether a component angle detected by the G-sensor is greater than a preset directional value, and determines a change in the component angle detected by the G-sensor within a determination time to decide the moving state is in compliance with the shooting operation.

In an embodiment of the invention, after the communication unit receives a camera signal, the processing unit detects the moving state of the wearable apparatus via the G-sensor.

In an embodiment of the invention, the zoom sensing module includes infrared emitters and corresponding infrared receivers, and the infrared emitters and the infrared receivers are respectively arranged and disposed on the first surface of the ring body facing the human body. The processing unit determines a receive time that the infrared receivers receive an infrared light emitted by the corresponding infrared emitters to decide the distance between each of the infrared emitters or each of the infrared receivers and the human body, and decide the focus adjustment signal according to the distance between each of the infrared emitters or each of the infrared receivers and the human body.

In an embodiment of the invention, the zoom sensing module includes capacitive sensors. The processing unit decides the focus adjustment signal according to a change in capacitance value of the zoom operation sensed by the capacitive sensors.

In an embodiment of the invention, the zoom sensing module includes a pressure switch. The processing unit decides the focus adjustment signal according to a change in pressure of the zoom operation sensed by the pressure switch.

In another embodiment of the invention, the zoom sensing module includes a touch display for generating a zoom control screen on the touch display region, the touch display is disposed on a second surface of the ring body facing away from the human body, and the touch display includes a touch indication region. The processing unit decides the focus adjustment signal according to the zoom operation received in the touch indication region.

The invention provides a control method of a wearable apparatus suitable for a wearable apparatus having a ring body. The ring body surrounds the periphery of the human body. The control method includes the following steps. The moving state of the wearable apparatus is detected via the G-sensor. When the moving state of the wearable apparatus is determined as a shooting operation, whether a zoom operation is detected via a zoom sensing module is determined so as to decide whether to generate a focus adjustment signal. A shooting start signal is sent via a communication unit.

In an embodiment of the invention, the detection of the moving state of the wearable apparatus via the G-sensor includes the following steps. Whether a component angle detected by the G-sensor is greater than a preset directional value is determined, and a change in the component angle detected by the G-sensor is determined within a determination time to decide the moving state is in compliance with the shooting operation.

In an embodiment of the invention, the following steps are further included before the moving state of the wearable apparatus is detected via the G-sensor. A camera signal is received via the communication unit.

In an embodiment of the invention, the zoom sensing module includes infrared emitters and corresponding infrared receivers, and the infrared emitters and the infrared receivers are respectively arranged and disposed on the first surface of the ring body facing the human body. The determination of whether a zoom operation is detected via a zoom sensing module so as to decide whether to generate a focus adjustment signal includes the following steps. The receive time that the infrared receivers receive an infrared light emitted by the corresponding infrared emitters is determined. The distance between each of the infrared emitters or each of the infrared receivers and the human body is decided. The focus adjustment signal is decided according to the distance between each of the infrared emitters or each of the infrared receivers and the human body.

In an embodiment of the invention, the zoom sensing module includes capacitive sensors. The determination of whether a zoom operation is detected via a zoom sensing module so as to decide whether to generate a focus adjustment signal includes the following steps. The focus adjustment signal is decided according to the change in capacitance value of the zoom operation sensed by the capacitive sensors.

In an embodiment of the invention, the zoom sensing module includes a pressure switch. The determination of whether a zoom operation is detected via a zoom sensing module so as to decide whether to generate a focus adjustment signal includes the following steps. The focus adjustment signal is decided according to the change in pressure of the zoom operation sensed by the pressure switch.

In an embodiment of the invention, the zoom sensing module includes a touch display for generating a zoom control screen on the touch display region, and the touch display includes a touch indication region. The determination of whether a zoom operation is detected via a zoom sensing module so as to decide whether to generate a focus adjustment signal includes the following steps. The focus adjustment signal is decided according to the zoom operation received in the touch indication region.

Based on the above, the wearable apparatus in an embodiment of the invention has a ring body surrounding the periphery of the human body, and after the G-sensor detects the wearable apparatus is in a view operation, the relative position of each of the auxiliary sensors to the human body is determined, and a frame is displayed on the corresponding display block in the flexible screen. Moreover, the wearable apparatus in another embodiment of the invention can further generate a trigger signal via the determination of the moving state of the wearable apparatus, so as to provide a signal to control the shooting function or the lens zoom operation of a remote photographic equipment (such as a mobile phone), thus resulting in another added value to the wearable apparatus.

Several exemplary embodiments accompanied with figures are described in detail below to further describe the disclosure in details.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a wearable apparatus according to an embodiment of the invention.

FIG. 2 is a schematic of a ring body according to an embodiment of the invention.

FIG. 3 is an example of a display block on a flexible screen.

FIG. 4A to FIG. 4D are examples of the disposition of auxiliary sensors.

FIG. 5 is a flow chart of a display method of a wearable apparatus according to an embodiment of the invention.

FIG. 6A is a definition of three axes of a G-sensor.

FIG. 6B is a schematic example of the actuation of a G-sensor.

FIG. 7 is an example of the determination of a relative position via infrared emitters and infrared receivers.

FIG. 8 is an example of the determination of a relative position via light emitters and light receivers.

FIG. 9 is an example of the determination of a relative position via magneto-resistive sensors.

FIG. 10 is an example of the determination of a relative position via capacitive sensors.

FIG. 11A is an example of tight fit of the ring body of FIG. 2 and a human body.

FIG. 11B is an example of the determination of a relative position via heartbeat sensors.

FIG. 12 is a block diagram of a wearable apparatus according to an embodiment of the invention.

FIG. 13 is a flow chart of a control method of a wearable apparatus according to an embodiment of the invention.

FIG. 14 is a schematic example of the actuation of a G-sensor.

FIG. 15A and FIG. 15B are examples of zoom control.

FIG. 16 is an example of the interaction between a wearable apparatus and an image capture apparatus.

### DESCRIPTION OF THE EMBODIMENTS

A flexible display adopts a flexible material substrate that is not readily broken such that the display can be bended or curled. As a result, the design of the electronic apparatus is more flexible. Accordingly, an embodiment of the invention provides a wearable apparatus having a ring body capable of surrounding the periphery of a human body such as a wrist or an a in, a flexible screen is disposed on one side of the ring body, and a plurality of auxiliary sensors (such as light receivers and light emitters or magneto-resistive sensors) are arranged and disposed on another side of the ring body facing the human body. Then, the wearable apparatus of an embodiment of the invention respectively determines the moving state of the wearable apparatus and the wearing state on the human body (such as the relative position or distance of the human body to each of the auxiliary sensors) via a G-sensor and a plurality of auxiliary sensors, so as to display a frame on the display block in the flexible screen. Alternatively, the wearable apparatus of an embodiment of the invention can also generate a trigger signal via the determination of a tilt condition of the wearable apparatus by the G-sensor. Moreover, the wearable apparatus of an embodiment of the invention can further detect a zoom control operation by controlling the sensors, and thereby control the camera function of an external image capture apparatus (such as a digital camera or a smartphone). In the following, a plurality of embodiments within the spirit of the invention are provided, suitable adjustment can be made to the embodiments as needed by those applying the embodiments, and the embodiments are not limited to the contents described below.

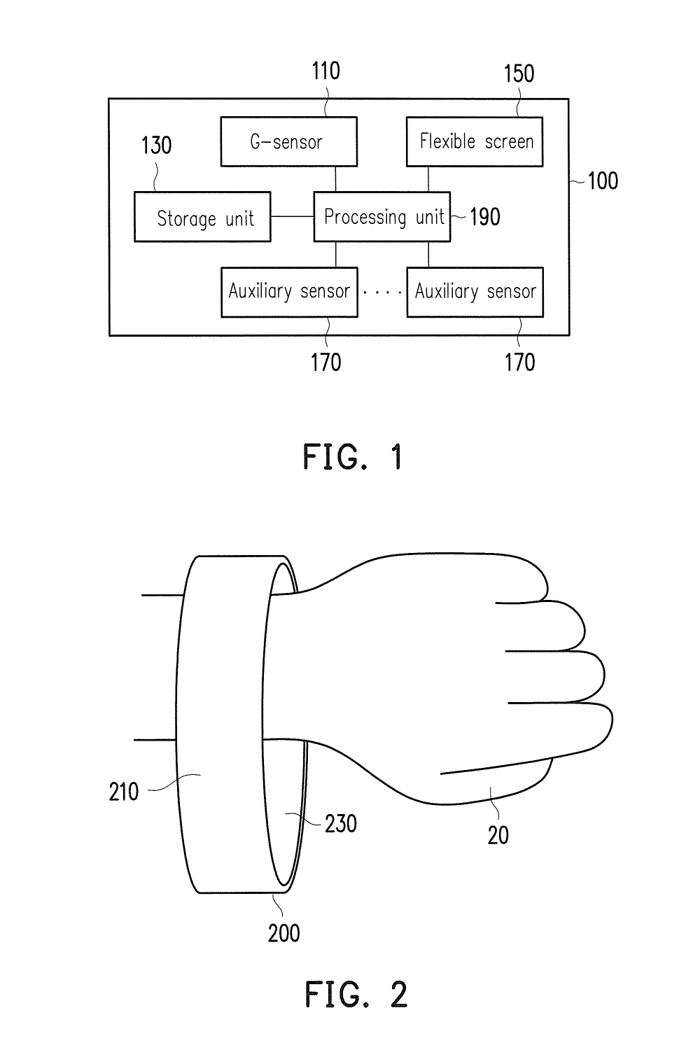

FIG. 1 is a block diagram of a wearable apparatus according to an embodiment of the invention. Referring to FIG. 1, a wearable apparatus 100 includes a G-sensor 110, a storage unit 130, a flexible screen 150, a plurality of auxiliary sensors 170, and a processing unit 190. The wearable apparatus 100 can be a wearable apparatus of the type of, for instance, a smart watch or a smart bracelet. In the present embodiment, the wearable apparatus 100 is suitable to be worn on the human skin surface via physical contact. The wearable apparatus 100 has a ring body, and the ring body surrounds the periphery of the human body (such as a wrist or an arm).

For instance, FIG. 2 is a schematic of a ring body according to an embodiment of the invention. Referring to FIG. 2, after a ring body 200 is worn on a hand 20 of a user; the ring body 200 may be completely surrounded with the periphery of the hand 20. It should be mentioned that, in other embodiments, the ring body 200 may have different sizes or shapes (such as circular cross-section or an oval cross-section), the ring body 200 and the human body may be a loose fit or a tight fit, and the exterior of the ring body 200 can be adjusted according to design requirements. Moreover, the ring form of the ring body 200 is only used to describe the form of the wearable apparatus 100 worn on a human body, and a wearable apparatus 100 not worn on a human body can also be in the form of a rectangular strip, and is not limited thereto.

The G-sensor 110 can be a tri-axial G-sensor or a sensing module combined with a dynamic sensor such as a gyro sensor, an electronic compass, or a geomagnetic sensor. The G-sensor 110 is used to sense the moving state (such as rotation, flipping, shaking, or translational movement) of the wearable apparatus 100.

The storage unit 130 can be any type of fixed or movable random access memory (RAM), read-only memory (ROM), flash memory, a similar device, or a combination of the devices.

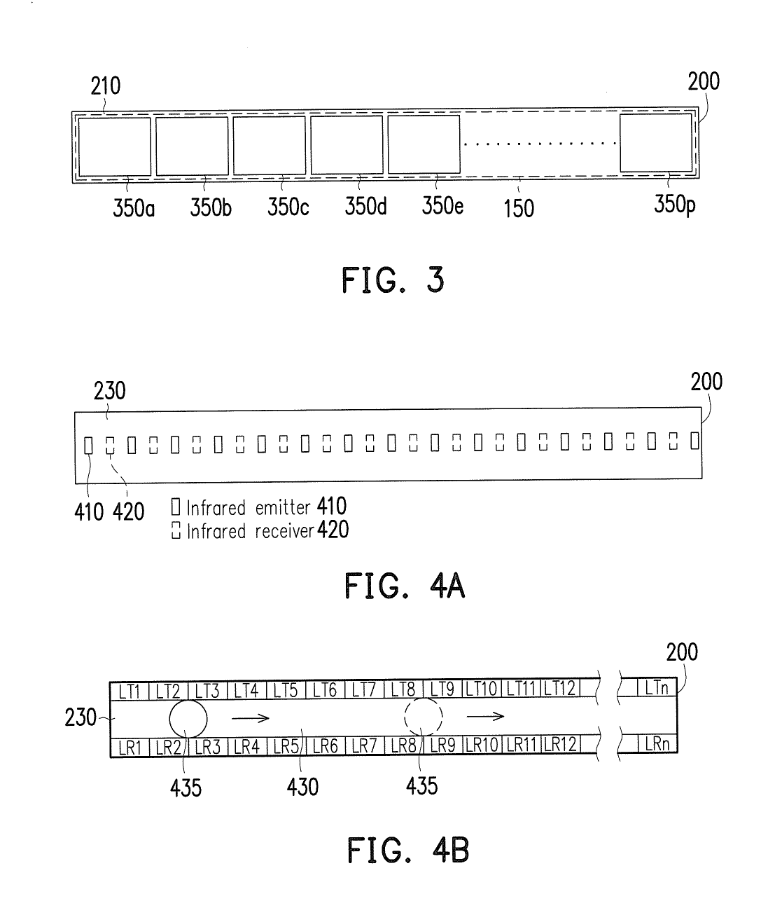

The flexible screen 150 can be a liquid crystal display (LCD), a light-emitting diode (LED) display, a field-emission display (FED), or display panels of other types of displays. The flexible screen 150 is disposed on a side (such as the surface 210 of FIG. 2) of the ring body 200 facing away from the human body in a surrounding manner. In an embodiment, the display region of the flexible screen 150 can be divided into a plurality of display blocks. For instance, FIG. 3 is an example of a display block on the flexible screen 150. Referring to FIG. 2 and FIG. 3, the surface 210 of the ring body 200 includes a plurality of display blocks 350a to 350p, and p is a positive integer. In other embodiments, the display blocks 350a to 350p may have different numbers, sizes, positions, and shapes, and the display blocks 350a to 350p may also be arranged in an overlapping manner. Adjustments can be made to the display blocks 350a to 350p according to design requirements.

Each of the auxiliary sensors 170 can be one of an infrared emitter and a corresponding infrared receiver, a light emitter and a corresponding light receiver, a magneto-resistive (MR) sensor, a capacitive sensor, a humidity sensor, a conductor apparatus, or a heartbeat sensor (or pulse sensor). The auxiliary sensors 170 are respectively arranged and disposed on another side of the ring body 200 facing the human body (such as a surface 230 of FIG. 2). It should be mentioned that, the humidity sensors can include an electrolyte humidity sensor, and the magneto-resistive sensors can be, for instance, Hall circuits, and any sensor having the same or similar efficacy can be applied in the auxiliary sensors 170 in the present embodiment, and the embodiments of the invention are not particularly limited.

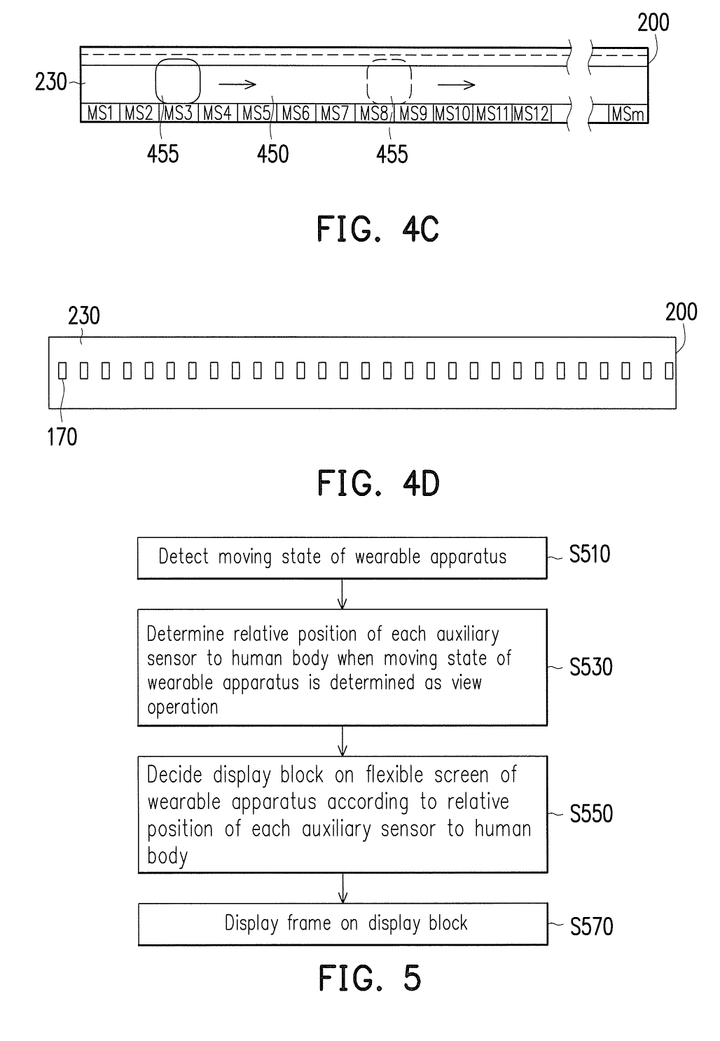

For instance, FIG. 4A to FIG. 4D are examples of the disposition of the auxiliary sensors 170. Referring first to FIG. 2 and FIG. 3A, the auxiliary sensors 170 are infrared emitters 410 and infrared receivers 420. The infrared emitters 410 and the infrared receivers 420 are alternately arranged and disposed on the surface 230 of the ring body 200.

Referring to FIG. 2 and FIG. 4B, the auxiliary sensors 170 are light emitters LT1 to LTn and light receivers LR1 to LRn. The light emitters LT1 to LTn and the light receivers LR1 to LRn are arranged and disposed on the surface 230 of the ring body 200 in a manner that the light emitters LT1 to LTn and the light receivers LR1 to LRn are symmetrical to one another, and n is a positive integer. Moreover, a ball channel 430 is disposed between the light emitters LT1 to LTn and the light receivers LR1 to LRn arranged on the surface 230 of the ring body 200, and a ball 435 is disposed on the ball channel 430. The ball 435 can roll on the ball channel 430. For instance, the ball 435 represented by a solid line is moved to the ball 435 represented by a dashed line.

Referring to FIG. 2 and FIG. 4C, the auxiliary sensors 170 are magneto-resistive sensors MS1 to MSm arranged on the surface 230 of the ring body 200, and m is a positive integer. Moreover, a slide channel 450 is disposed adjacent to the magneto-resistive sensors MS1 to MSm arranged on the surface 230 of the ring body 200, and a magnetic device 455 is disposed on the slide channel 450. The magnetic device 455 can slide on the slide channel 450. For instance, the magnetic device 455 represented by a solid line is moved to the magnetic device 455 represented by a dashed line.

Referring to FIG. 2 and FIG. 4D, the auxiliary sensors 170 are one of capacitive sensors, humidity sensors, conductor apparatuses, or heartbeat sensors. The auxiliary sensors 170 are evenly arranged on the surface 230 of the ring body 200.

It should be mentioned that, the above schematics are only exemplary, and in other examples, the auxiliary sensors 170 (such as the infrared emitters 410 and the infrared receivers 420 of FIG. 4A, the light emitters LT1 to LTn and the light receivers LR1 to LRn of FIG. 4B, the magneto-resistive sensors MS1 to MSm of FIG. 4C, or the auxiliary sensors 170 of FIG. 4D) may have different sizes, shapes, and disposition positions, and modifications can be made thereto according to design requirements.

The processing unit 190 is, for instance, a central processing unit (CPU) or a programmable microprocessor, a digital signal processor (DSP), a programmable controller, an application-specific integrated circuit (ASIC), a system on chip (SoC), other similar devices, or a combination of the devices for general use or specific use. The processing unit 190 is coupled to the G-sensor 110, the storage unit 130, the flexible screen 150, and the auxiliary sensors 170. In the present embodiment, the processor 190 is used to process all tasks of the wearable apparatus 100 of the present embodiment.

FIG. 5 is a flow chart of a display method of a wearable apparatus 100 according to an embodiment of the invention. Referring to FIG. 5, the method of the present embodiment is suitable for the wearable apparatus 100 of FIG. 1 and the ring body 200 of FIG. 2. In the following, the display method of an embodiment of the invention is described with reference to each device in the wearable apparatus 100 and the ring body 200 of FIG. 2. Each of the processes of the present method can be adjusted according to embodiment conditions and is not limited thereto.

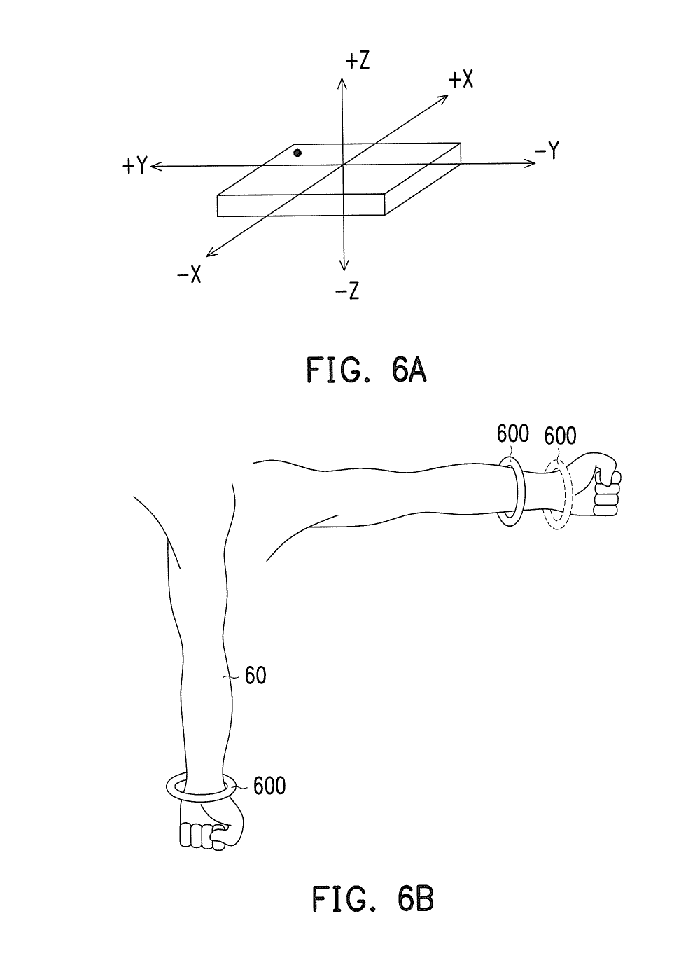

In step S510, the processing unit 190 detects the moving state of the wearable apparatus 100 via the G-sensor 110. For instance, FIG. 6A is a definition of three axes (such as x-axis, y-axis, and z-axis) of the G-sensor 110. The x-axis and the y-axis are, for instance, coordinate axes parallel to the ground, the z-axis is, for instance, a coordinate axis perpendicular to the ground, and the axes are perpendicular to one another. FIG. 6B is a schematic example of the actuation of the G-sensor 110. Referring to FIG. 6B, a hand 60 of a user wears a wearable apparatus 600. In the case that the hand 60 of the user is placed with the palm facing down at the beginning, after the user raises the hand 60, the wearable apparatus 600 represented by a dashed line in the upper right of FIG. 6B is moved to the position of the wearable apparatus 600 represented by a solid line. During the moving process of the wearable apparatus 600, the G-sensor 110 generates −gx, +gy, and +gz values of a preset size (such as 1 g; 9.8 m/sec²), and the order that the values are generated is −gx to +gy to +gz. When the processing unit 190 receives the −gx, +gy, and +gz values generated by the G-sensor 110, the processing unit 190 compares the size and the order of the −gx, +gy, and +gz values with a preset reference data corresponding to a view operation to determine that the moving state of the wearable apparatus 600 is in compliance with the view operation.

On the other hand, in one case, the hand 60 of the user is raised at the beginning and then the hand 60 of the user is lowered. During the moving process of the wearable apparatus 600, the G-sensor 110 generates +gx, −gy, and −gz values of a preset size (such as 1 g; 9.8 m/sec²), and the order that the values are generated is +gx to −gy to −gz. When the processing unit 190 receives the +gx, −gy, and −gz values generated by the G-sensor 110, the processing unit 190 compares the size and the order of the +gx, −gy, and −gz values with a preset reference data corresponding to a non-view operation (or a view-complete operation . . . etc.) to determine whether the moving state of the wearable apparatus 600 is in compliance with the non-view operation.

In step S530, when the processing unit 190 determines the moving state of the wearable apparatus 100 as a view operation, the relative position of each of the auxiliary sensors 170 to the human body is determined via the auxiliary sensors 170. In the first embodiment, the auxiliary sensors 170 are infrared emitters (such as the infrared emitters 410 in FIG. 4A) and corresponding infrared receivers (such as the infrared receivers 420 in FIG. 4A). The processing unit 190 respectively emits an infrared light via the infrared emitters, and respectively receives the infrared light reflected from the human body via the infrared receivers. Moreover, the processing unit 190 compares the receive time that each of the infrared receivers receives the infrared light to decide the relative position of each of the auxiliary sensors 170 to the human body.

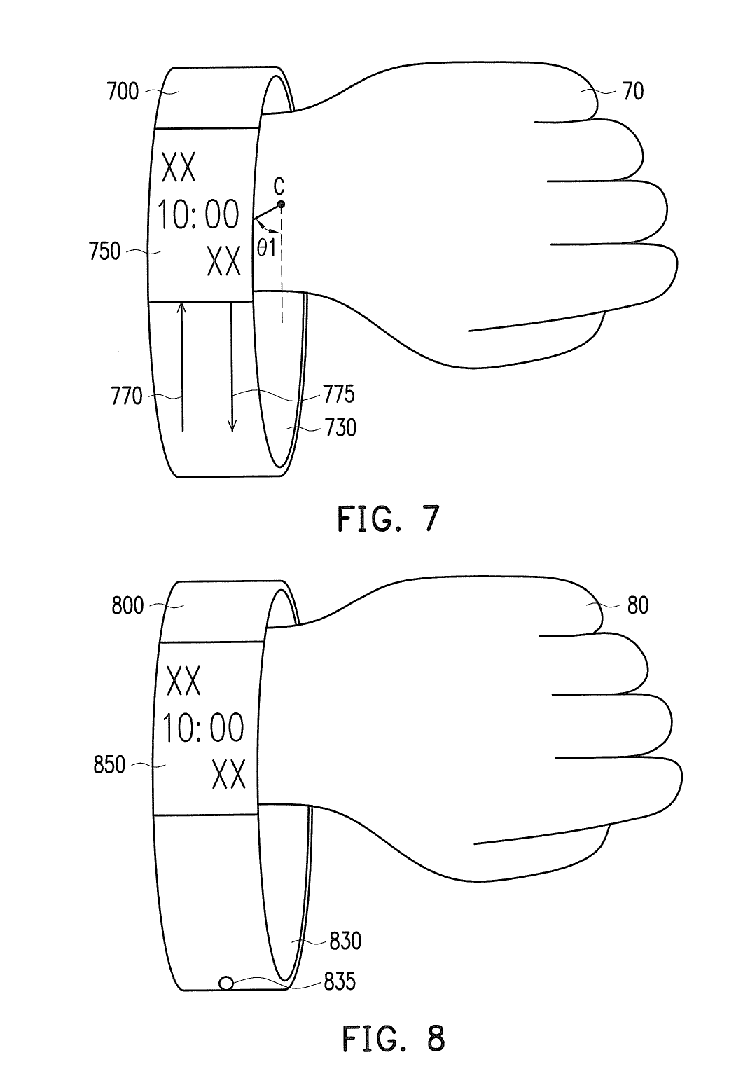

For instance, FIG. 7 is an example of the determination of a relative position via infrared emitters and infrared receivers. Referring to FIG. 3A and FIG. 7, similarly to the surface 230 of FIG. 4A, the infrared emitters 410 and the infrared receivers 420 are arranged and disposed on a surface 730 of a wearable apparatus 700. In one case, the infrared emitter 410 below the hand 70 emits an infrared light 770 and the infrared receiver 420 receives an infrared light 775 reflected from the hand 70. The processing unit 190 can calculate the distance between each of the infrared receivers 420 or each of the infrared emitters 410 and the hand 70 by calculating the receive time of the travel of the infrared lights 770 and 775.

In the second embodiment, the auxiliary sensors 170 are light emitters (such as the light emitters LT1 to LTn of FIG. 4B) and corresponding light receivers (such as the light receivers LR1 to LRn of FIG. 4B). The processing unit 190 respectively emits light sources via the light emitters and then respectively receives the light sources via the light receivers. Moreover, the processing unit 190 determines the degree of shielding (such as the illumination or intensity of the light source, or light sensing value) of a ball (such as the ball 435 of FIG. 4B) sensed by the light receivers to decide the relative position of each of the auxiliary sensors 170 to the human body.

For instance, FIG. 8 is an example of the determination of a relative position via light emitters and light receivers. Referring to FIG. 4B and FIG. 8, similarly to the surface 230 of FIG. 4B, the light emitters LT1 to LTn and the light receivers LR1 to LRn are arranged and disposed on a surface 830 of a wearable apparatus 800. The light emitters LT1 to LTn emit light, and the light receivers LR1 to LRn correspond to the light emitted by the light emitters LT1 to LTn. In FIG. 4B, when the ball 435 is moved to a position, such as between the light emitter LT2 and the light receiver LR2, the ball 435 shields the light source emitted by the light emitter LT2, and the corresponding light receiver LR2 does not receive a light signal or the received light signal is less than a preset illumination or intensity (such as 10 lux). Accordingly, the ball 835 in FIG. 8 also shields emitted light sources of the light emitters and received light sources of light receivers at one or two corresponding positions.

In one case, the user raises the hand 80 to view the wearable apparatus 800, and then the processing unit 190 can determine the position of the ball 835 according to, for instance, the light sensing values of the light receivers LR1 to LRn (such as between the light emitter LTq and the light receiver LRq, 1≦q≦n). Sagging occurs to the wearable apparatus 100 of the invention due to the weight of the ring body 200 and gravity, and the processing unit 190 determines the position of the ball 835 is located at the lowest point position on one side of the ring body of the wearable apparatus 800 facing the hand 80, and determines a light emitter or a light receiver (such as the light emitter LTq and the light receiver LRq) adjacent to the ball 835 is the auxiliary sensor 170 farthest from the hand 80.

In the third embodiment, the auxiliary sensors 170 are magneto-resistive sensors (such as the magneto-resistive sensors MS1 to MSm of FIG. 4C). The processing unit 190 compares a magnetic line of force sensed from a magnetic device (such as the magnetic device 455 of FIG. 4C) by the magneto-resistive sensors to decide the relative position of each of the auxiliary sensors to the human body.

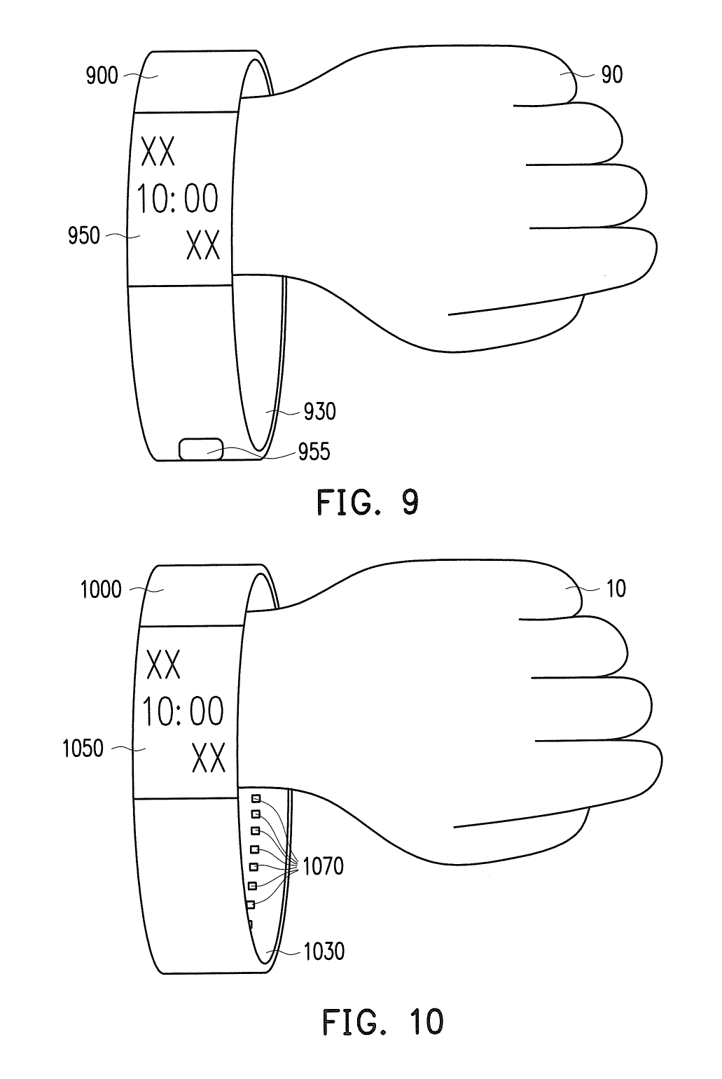

For instance, FIG. 9 is an example of the determination of a relative position via magneto-resistive sensors. Referring to FIG. 4C and FIG. 9, similarly to the surface 230 of FIG. 4C, magneto-resistive sensors MS1 to MSm are arranged and disposed on a surface 930 of a wearable apparatus 900. In FIG. 4C, when the magnetic device 455 is moved to a position, such as adjacent to the magneto-resistive sensor MS3, that is, the magnetic device 455, then the processing unit 190 can determine the position of the magnetic device 455 according to the magnetic line of force or the change in the magnetic line of force sensed from the magnetic device 455 by each of the magneto-resistive sensors MS1 to MSm. Accordingly, the processing unit 190 can also determine the position of the magnetic device 955 on the surface 930 in FIG. 9.

In the case that the user raises the hand 90 to view the wearable apparatus 900, the processing unit 190 can determine the position (such as adjacent to the magneto-resistive sensor MSr, 1≦r≦m) of the magnetic device 955 according to, for instance, a magnetic line of force, determine the position of the magnetic device 955 is located at the lowest point position of one side of the ring body of the wearable apparatus 900 facing the hand 90, and determine a magneto-resistive sensor (such as the magneto-resistive sensor MSr) adjacent to the magnetic device 955 is the auxiliary sensor 170 farthest from the hand 90.

In the fourth embodiment, the auxiliary sensors 170 are capacitive sensors. The processing unit 190 determines the sensing state (such as whether the human body is sensed) sensed from the human body by the capacitive sensors to decide the relative position of each of the auxiliary sensors 170 to the human body.

For instance, FIG. 10 is an example of the determination of a relative position via capacitive sensors. Referring to FIG. 4D and FIG. 10, capacitive sensors 1070 are arranged and disposed on a surface 1030 of a wearable apparatus 1000 similarly to the auxiliary sensors 170 on the surface 230 of FIG. 4D. In FIG. 10, a portion of the capacitive sensors 1070 respond to the hand 10, and another portion of the capacitive sensors 1070 do not respond to the hand 10.

In one case, the user raises the hand 90 to view the wearable apparatus 1000, and then the processing unit 190 can determine that, for instance, 12 capacitive sensors 1070 sense the skin of the hand 10, and 18 capacitive sensors 1070 do not sense the skin of the hand 10. For instance, the processing unit 190 divides the number of the capacitive sensors 1070 that do not perform sensing by 2 (divides by 2 if the number is even, and divides by 2 after adding 1 if the number is odd), then the processing unit 190 can estimate the lowest point position of the surface 1030 of the wearable apparatus 1000 is, for instance, located adjacent to the position of the ninth capacitive sensor 1070 that does not perform sensing, and can also determine the capacitive sensor 1070 is the auxiliary sensor 170 farthest from the hand 10.

In the fifth embodiment, the auxiliary sensors 170 are humidity sensors. The processing unit 190 determines the humidity sensed from the human body by the humidity sensors to decide the relative position of each of the auxiliary sensors 170 to the human body. For instance, when the humidity sensors on the wearable apparatus 100 are completely fitted to, for instance, a wrist, the detected humidity is higher than the humidity in an unfitted case. Moreover, when the wearable apparatus 100 is worn on the wrist, sagging also occurs due to weight and gravity. As a result, a portion of the humidity sensors on one side of the ring body of the wearable apparatus 100 facing the wrist are in contact with the user's skin, and another portion of the humidity sensors are not in contact with the user's skin (such as the case of FIG. 10). The processing unit 190 compares the humidity value detected by each of the humidity sensors to a preset humidity value to determine whether each of the humidity sensors is in contact with the human body (such as the skin of the wrist), and thereby determine the relative position of each of the humidity sensors to the human body. Moreover, in the present embodiment, the farthest humidity sensor from the human body can also be decided with reference to the arrangement and disposition of the auxiliary sensors 170 on the surface 230 of FIG. 4D and relevant descriptions of FIG. 10.

For instance, using FIG. 10 as an example, in the case that 30 humidity sensors are disposed on the wearable apparatus 1000 (such as replacing the capacitive sensors 1070 with humidity sensors), if 20 humidity sensors sense higher humidity, and another 10 humidity sensors sense lower humidity, 30 humidity sensors send sensed data to the processing unit 190. The processing unit 190 can then know which humidity sensors have lower sensed humidity values (such as a relative humidity value less than 40%). Since the sagging region of the ring body of an embodiment of the invention is in a region for which skin contact is not sensed, the processing unit 190 divides the number of the humidity sensors having lower sensed humidity by 2 (divides by 2 in the case of an even number, and divides by 2 after adding 1 in the case of an odd number). Then, the processing unit 190 can estimate the lowest point position of the surface 1030 of the wearable apparatus 1000 is, for instance, located adjacent to the position of the fifth humidity sensor having lower sensed humidity, and can also determine the humidity sensor is the auxiliary sensor 170 farthest from the hand 10.

In the sixth embodiment, the auxiliary sensors 170 are conductor apparatuses, and each of the conductor apparatuses is bridged with the processing unit 190 via a voltage loop. The processing unit 190 determines the change in impedance of the conductor apparatuses to decide the relative position of each of the auxiliary sensors 170 to the human body. For instance, each of the conductor apparatuses respectively provides a small current (such as 100 milliamperes), and when the human body is in contact with the conductor apparatus, the impedance inside the conductor apparatus is changed. Accordingly, the processing unit 190 can determine whether the impedance of each of the conductor apparatuses is significantly changed (such as the change in impedance is greater than a preset change in impedance value (such as 3 ohms)), so as to determine whether each of the conductor apparatuses is in contact with the human body (such as the skin of the wrist), and thereby determine the relative position of each of the conductor apparatuses to the human body.

For instance, when the user raises an arm to view the wearable apparatus 100, sagging also occurs to the ring body of the wearable apparatus 100 due to weight and gravity. As a result, a portion of the conductor apparatuses on a side of the ring body of the wearable apparatus 100 facing the wrist are in contact with the user's skin, and another portion of the conductor apparatuses are not in contact with the user's skin (such as the case of FIG. 10). Moreover, in the present embodiment, the farthest conductor apparatus from the human body can also be decided with reference to the arrangement and disposition of the auxiliary sensors 170 on the surface 230 of FIG. 4D and relevant descriptions of FIG. 10. For instance, using FIG. 10 as an example, in the case that 15 conductor apparatuses are disposed on the wearable apparatus 1000 (such as replacing the capacitive sensors 1070 with conductor apparatuses), if 10 conductor apparatuses sense significant change in impedance (such as a change in impedance of 10 ohms), and another 5 conductor apparatuses do not sense significant change in impedance (such as no change in impedance), 15 conductor apparatuses send sensed data to the processing unit 190. The processing unit 190 can thus know which conductor apparatuses sense significant change in impedance (such as a change in impedance greater than 7 ohms). Since the sagging region of the ring body of an embodiment of the invention is in a region for which skin contact is not sensed, the processing unit 190 divides the number of the conductor apparatuses sensing significant change in impedance by 2 (divides by 2 in the case of an even number, and divides by 2 after adding 1 in the case of an odd number). Then, the processing unit 190 can estimate the lowest point position of the surface 1030 of the wearable apparatus 1000 is, for instance, located adjacent to the position of the third conductor apparatus sensing significant change in impedance, and can also determine the conductor apparatus is the auxiliary sensor 170 farthest from the hand 10.

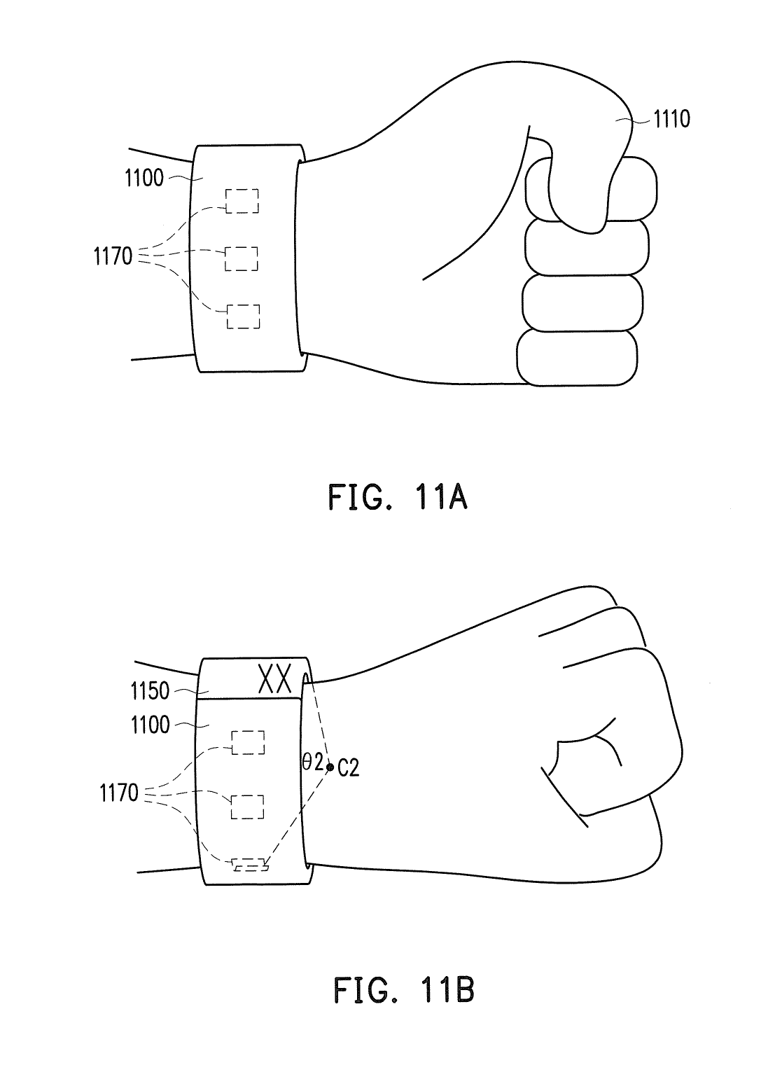

In the seventh embodiment, FIG. 11A is an example of tight fit of the ring body 200 and a human body of FIG. 2. The auxiliary sensors 170 of FIG. 1 are heartbeat sensors 1170 on a wearable apparatus 1100, and the heartbeat sensors 1170 are disposed on a side of the ring body of the wearable apparatus 1100 facing the human body. The heartbeat sensors 1170 of the present embodiment can also be arranged and disposed according to the auxiliary sensors 170 on the surface 230 of FIG. 4D. The processing unit 190 compares ECG signals detected by the heartbeat sensors 1170 to decide the relative position of each of the heartbeat sensors 1170 to a determination region (such as inside of wrist or outside of wrist) of the human body. For instance, the processing unit 190 can determine the heartbeat sensor 1170 having the strongest detected ECG signal as the heartbeat sensor 1170 adjacent to the inside of the wrist. FIG. 11B is an example of the determination of a relative position via heartbeat sensors 1170. In the case that the ECG signal sensed by the bottom-most of the three heartbeat sensors 1170 in FIG. 11B is strongest, the processing unit 190 can determine the bottom-most heartbeat sensor 1170 as the heartbeat sensor 1170 adjacent to the inside of the wrist.

In step S550, the processing unit 190 decides a display block on the flexible screen 150 of the wearable apparatus 100 according to the relative position of each of the auxiliary sensors 170 to the human body. In an embodiment, the processing unit 190 decides an angle range (such as 70 degrees to 100 degrees or 90 degrees to 110 degrees) of a reference sensor from one of the auxiliary sensors 170 extended along the flexible screen 150 according to the relative position of each of the auxiliary sensors 170 to the human body. A block for which the angle range corresponds to the flexible screen 150 is used as the display block.

Using FIG. 7 as an example, in the example of FIG. 7, a processing unit 190 can calculate the distance between each of the infrared receivers 420 or each of the infrared emitters 410 and the hand 70 and decide one of the infrared receivers 420 having the longest receive time as the reference sensor. Since sagging occurs to the wearable apparatus 700 of an embodiment of the invention due to inherent weight and gravity, in the present example, the infrared receiver 420 having the longest receive time is also the infrared receiver 420 farthest from the hand 70. Then, the processing unit 190 decides a reference center C (such as the center of the ring body of the wearable apparatus 7000 or the center of the cross-section of the wrist), and then calculates the connection between the center C to the farthest infrared receiver 420 and an angle range extended by, for instance, 70 degrees to 100 degrees along the surface 730 in a clockwise direction (i.e., angle θ1 is 70 degrees to 100 degrees), and determines a display block 750 on another side of the surface 730 corresponding to the angle range.

Moreover, the examples of FIG. 8 to FIG. 10 are similar to the above, wherein the processing unit 190 decides one of the light receivers having the strongest degree of shielding (such as the light receiver LRq in the case of FIG. 8) as the reference sensor, decides one of the magneto-resistive sensors of a preset direction of magnetic line of force (such as the magneto-resistive sensor MSr in the case of FIG. 9) as the reference sensor, decides one of the capacitive sensors that does not sense (such as the ninth capacitive sensor 1070 in the case of FIG. 10) as the reference sensor, decides one of the humidity sensors having a sensed humidity less than a preset humidity (such as the humidity sensor arranged in the middle position in a plurality of humidity sensors having a humidity less than a preset humidity) as the reference sensor, or decides one of the conductor apparatuses without change in impedance (such as the conductor apparatus arranged in the middle position in a plurality of conductor apparatuses without change in impedance) as the reference sensor, so as to respectively decide display blocks 850, 950, and 1050.

Moreover, in the seventh embodiment, the processing unit 190 can determine one of the heartbeat sensors having the strongest detected ECG signal (such as the heartbeat sensor adjacent to the inside of the wrist) as the reference sensor to decide the display block on the flexible screen 150 according to the position of the reference sensor. For instance, referring to FIG. 11B, the processing unit 190 can decide the wrist is a center C2 and the angle range extended by, for instance, 160 degrees to 200 degrees (i.e., angle θ2 is 160 degrees to 200 degrees) in a clockwise direction along the ring body according to the connection of the center C2 to the heartbeat sensor 1170 having the strongest ECG signal (such as the bottom-most heartbeat sensor 1170), and determine a corresponding display block 1150 on another side of the ring body.

In step S570, the processing unit 190 can display a frame (such as time, picture, or image) on the display block of the ring body decided via step S550 (such as the display block 750 of FIG. 7, the display block 850 of FIG. 8, the display block 950 of FIG. 9, the display block 1050 of FIG. 10, or the display block 1150 of FIG. 11).

Moreover, in the case that the user lowers the raised hand, the processing unit 190 can detect the moving state of the wearable apparatus 110 is changed from a view operation to a non-view operation (or view-complete operation) via the G-sensor 110, and the processing unit can wait for a period (such as 1 second or 1.5 seconds) or not wait for a period (i.e., instant), and a frame is not displayed on the display block decided in step S550.

Accordingly, the user can view the frame displayed on the wearable apparatus 100 in a simple, rapid, and intuitive manner. Moreover, the user can arbitrarily wear the wearable apparatus 1000 on the wrist, and does not need to wear the wearable apparatus 100 in a traditional manner recommended by manufacturers. As a result, the aesthetic design of the wearable apparatus is further enhanced.

Moreover, although most electronic apparatuses having image capture function such as smartphones, tablet computers, or digital cameras generally have functions such as image capture, focus adjustment, and image zoom, most functions can only be operated on the electronic apparatus itself by the user. In the wearable apparatus having a ring body of the invention, via a remote control function, the external electronic apparatus having image capture function can be controlled, so as to provide a convenient operation mode to the user. Embodiments are provided below.

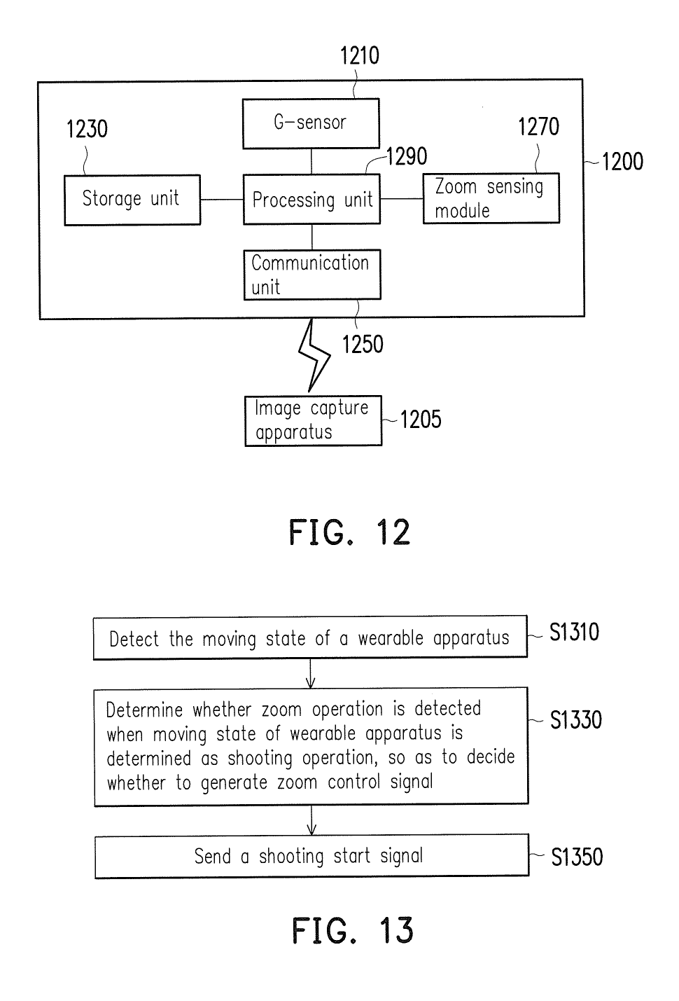

FIG. 12 is a block diagram of a wearable apparatus according to an embodiment of the invention. Referring to FIG. 12, a wearable apparatus 1200 includes a G-sensor 1210, a storage unit 1230, a communication unit 1250, a zoom sensing module 1270, and a processing unit 1290. The wearable apparatus 1200 can be a wearable apparatus of the type of, for instance, a smart watch or a smart bracelet. In the present embodiment, the wearable apparatus 1200 has a ring body, which is as described for FIG. 2, and is not repeated herein.

The G-sensor 1210, the storage unit 1230, and the processing unit 1290 of FIG. 12 are respectively as described for the G-sensor 110, the storage unit 130, and the processing unit 190 of FIG. 1 and are not repeated herein. The processing unit 1290 is coupled to the G-sensor 1210, the communication unit 1250, and the zoom sensing module 1270. Moreover, the communication unit 1250 can support, for instance, bluetooth, infrared ray (IR), WiFi, near-field communication (NFC), radio-frequency identification (RFID), or any type of wireless communication unit having the function of wireless transmission. In the present embodiment, the communication unit 1250 can be paired and connected with an image capture apparatus 1205 (external electronic apparatus having image capture function such as a digital camera, a smartphone, or a tablet computer) via the wireless transmission technology (such as bluetooth or NFC) of the communication unit 1250.

The zoom sensing module 1270 includes one of a plurality of infrared emitters and a plurality of corresponding infrared receivers, capacitive sensors, a pressure switch, or a touch display (such as a display (such as a liquid crystal display (LCD) or organic light-emitting display (OLED)) supporting a touch technique such as capacitive, resistive, and optical). The zoom sensing module 1270 is used to detect a zoom operation, and relevant steps are described in later embodiments.

FIG. 13 is a flow chart of a control method of the wearable apparatus 1200 according to an embodiment of the invention. Referring to FIG. 13, the method of the present embodiment is suitable for the wearable apparatus 1200 of FIG. 12 and the ring body 200 of FIG. 2. In the following, the control method of an embodiment of the invention is described with reference to each of the devices in the wearable apparatus 1200 and the ring body 200 of FIG. 2. Each of the processes of the present method can be adjusted according to embodiment conditions and is not limited thereto.

In step S1310, the processing unit 1290 detects the moving state of the wearable apparatus 1200 via the G-sensor 1210. In an embodiment, the processing unit 1290 determines whether a component angle (such as the projection component angle of gx or gy) detected by the G-sensor 1210 is greater than a preset directional value, and determines a change in the component angle detected by the G-sensor 1210 within a determination time to decide the moving state is in compliance with the shooting operation.

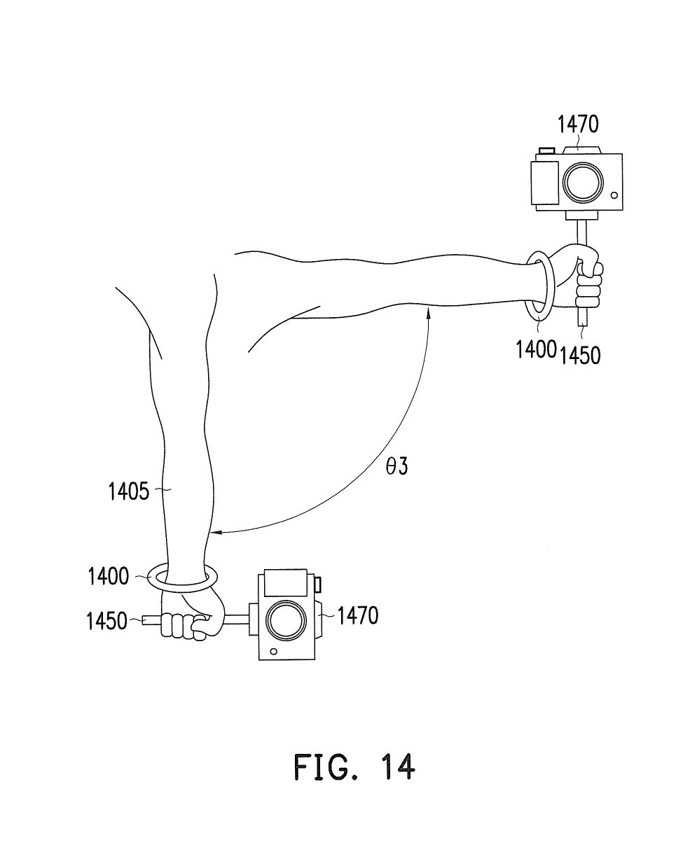

For instance, FIG. 14 is a schematic example of the actuation of the G-sensor 1210. Referring to both FIG. 6A and FIG. 14, in the case that a hand 1405 of the user is placed with the palm facing down at the beginning, after the user raises the hand 1405, the projection component angle of gx or gy is, for instance, a component angle θ3. The processing unit 1290 in the wearable apparatus 1400 can determine whether the component angle θ3 is greater than a preset directional value (such as 60 degrees or 80 degrees). When the processing unit 1290 determines the component angle θ3 is greater than the preset directional value, the processing unit 1290 then determines whether the change in the projection component angle of gx or gy and gz is within a preset range (such as 5 degrees or 10 degrees) within a determination time (such as 1 second or 1.5 seconds). If the change in the projection component angle of gx or gy and gz is within the preset range, then the processing unit 1290 can determine the moving state of the wearable apparatus 1400 is in compliance with the shooting operation.

It should be mentioned that, in addition to the determination of the moving state of the wearable apparatus 1400, in other embodiments, the auxiliary sensors 170 of, for instance, FIG. 1, can also be disposed on the wearable apparatus 1200 to determine whether the palm portion is changed (changes such as holding fist or releasing fist), or determine stretching and retracting actions of the arm . . . etc. Any determination of change in human pattern or physiological reaction can be viewed as the determination of whether the conditions of a shooting operation are met, and is not particularly limited.

It should be mentioned that, before the detection of the moving state of the wearable apparatus 1200 via the G-sensor 1210 in step S1310, the processing unit 1290 responds to the camera signal received by the communication unit 1250, then sets the wearable apparatus 1200 to the camera remote mode, and then detects the moving state of the wearable apparatus 1200.

In step S1330, when the processing unit 1290 determines the moving state of the wearable apparatus 1200 is a shooting operation, the processing unit 1290 determines whether a zoom operation is detected by a zoom sensing module 1270 so as to decide whether to generate a focus adjustment signal.

In an embodiment, the zoom sensing module 1270 is a plurality of infrared emitters and a plurality of corresponding infrared receivers, and the infrared emitters and the infrared receivers are respectively arranged and disposed on the first side of the ring body facing the human body. The processing unit 1290 determines a receive time that the infrared receivers receive an infrared light emitted by the corresponding infrared emitters to decide the distance between each of the infrared emitters or each of the infrared receivers and the human body, and decide the focus adjustment signal according to the distance between each of the infrared emitters or each of the infrared receivers and the human body.

For instance, each of the infrared emitters emits an infrared light, and the corresponding infrared receiver receives the infrared light reflected from the wrist. Then, the processing unit 1290 determines the receive time that each of the infrared receivers receives the infrared light emitted by the corresponding infrared emitter, and determines a change in value in the receive time of each of the infrared receivers within an infrared determination time (such as 1 second or 2 seconds), and thereby determines a degree of relaxation between the skin of the wrist and the zoom sensing module 1270. When the degree of relaxation is greater than a preset relaxation value, the processing unit 1290 generates, for instance, a zoom-in adjustment signal in the focus adjustment signal. When the degree of relaxation is less than the preset relaxation value, the processing unit 1290 generates, for instance, a zoom-out adjustment signal in the focus adjustment signal. Moreover, the processing unit 1290 sends the zoom-in adjustment signal or the zoom-out adjustment signal via the communication unit 1250. For instance, the wearable apparatus 1400 of FIG. 14 sends a zoom-in focus adjustment signal or a zoom-in focus adjustment signal to a digital camera 1470 (or an electronic apparatus or smartphone having image capture function).

In another embodiment, the zoom sensing module is a capacitive sensor. The processing unit 1290 decides the focus adjustment signal according to a change in capacitance value of the zoom operation sensed by the capacitive sensor. For instance, the capacitive sensor can be disposed on the second side of the ring body facing away from the human body to facilitate touching by the user. When the capacitive sensor detects an operation object (such as a finger), the capacitive sensor senses different capacitance values in response to different pressure forces of the operation object. If the processing unit 1290 then determines that the capacitance value within a time of, for instance, 1 second or 2 seconds is less than a preset capacitance value, then the processing unit 1290 accordingly generates a zoom-out focus adjustment signal. And if the capacitance value is greater than the preset capacitance value, then the processing unit 1290 generates a zoom-in focus adjustment signal.

In another embodiment, the zoom sensing module 1270 is a pressure switch. The processing unit 1290 decides the focus adjustment signal according to a change in pressure of a zoom operation sensed by the pressure switch. For instance, the pressure switch can be disposed on the second side of the ring body facing away from the human body to facilitate touching by the user. When the pressure switch detects an operation object (such as a finger), the capacitive sensor senses different pressure values in response to different pressure forces of the operation object. If the processing unit 1290 then determines that the capacitance value within a time of, for instance, 1 second or 2 seconds is less than a preset pressure value, then the processing unit 1290 accordingly generates a zoom-out focus adjustment signal. And if the capacitance value is greater than the preset pressure value, then the processing unit 1290 generates a zoom-in focus adjustment signal.

In another embodiment, the zoom sensing module 1270 includes a touch display for generating a zoom control screen on the touch display region, the touch display is disposed on a second side of the ring body facing away from the human body, and the touch display includes a touch indication region. The processing unit 1290 decides the focus adjustment signal according to the zoom operation received in the touch indication region.

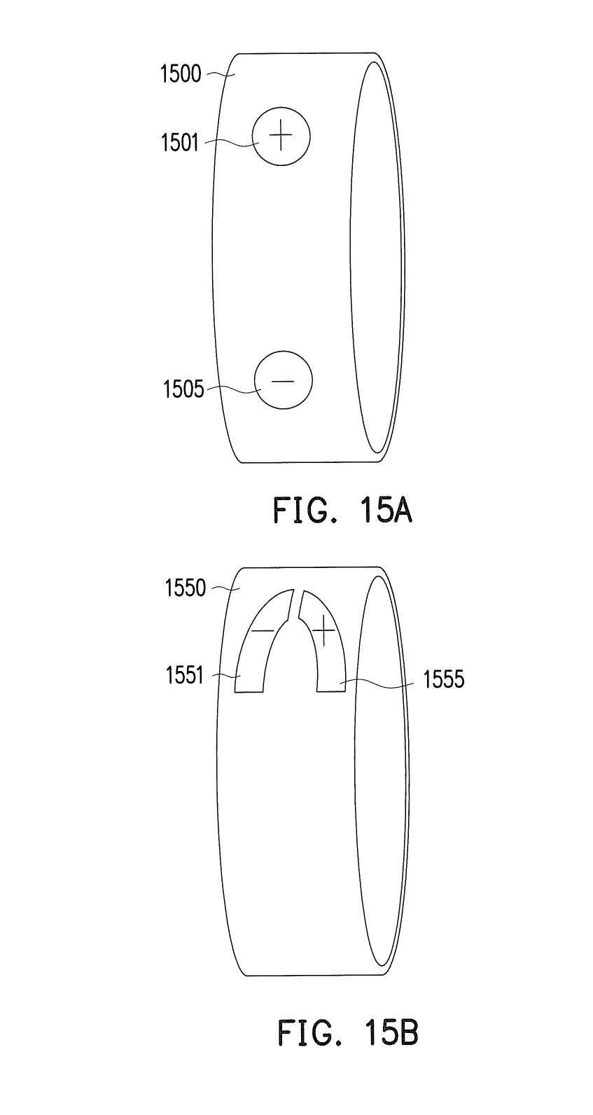

For instance, FIG. 15A and FIG. 15B are examples of zoom control. First, referring to FIG. 15A, it is assumed that the zoom sensing module 1270 (such as a touch display) of a wearable apparatus 1500 includes touch indication regions 1501 and 1505. The processing unit 1290 of the wearable apparatus 1500 generates a zoom control screen on the touch indication regions 1501 and 1505, and when the touch indication regions 1501 and 1505 receive a touch operation, the processing unit 1290 can determine a zoom operation is received. Referring to FIG. 15B, it is assumed that the zoom sensing module 1270 (such as a touch display) of a wearable apparatus 1550 includes touch indication regions 1551 and 1555. When the touch indication regions 1551 and 1555 receive a sliding operation, the processing unit 1290 can also determine a zoom operation is received. It should be mentioned that, in other embodiments, the touch indication regions 1551 and 1555 may have different sizes, shapes, and positions, the touch indication regions 1551 and 1555 can also be physical keys, and modifications can be made according to design requirements.

Moreover, the processing unit 1290 can further determine a sliding operation on the zoom sensing module 1270 (such as the touch indication regions 1551 and 1555 of FIG. 15B) to determine the degree of zooming. For instance, the touch indication region 1551 of FIG. 15B detects a sliding distance of a sliding operation to be 2 cm, and then the processing unit 1290 sends a zoom in focus adjustment signal of two magnifications via the communication unit 1250.

In an embodiment, after the processing unit 1290 determines the moving state of the wearable apparatus 1200 as a shooting operation and sets the wearable apparatus 1200 to a camera remote mode, the wearable apparatus 1200 can also combine the function of the wearable apparatus 100 of FIG. 1, and display, for instance, the touch indication regions 1501 and 1505 of FIG. 15A or the touch indication regions 1551 and 1555 of FIG. 15B on a specific display block in the flexible screen. In other words, the wearable apparatus 1200 also has the plurality of auxiliary sensors 170 of the wearable apparatus 100 in FIG. 1, and the wearable apparatus 1200 can determine the side of the ring body thereof facing the human body (such as a wrist) via, for instance, the auxiliary sensor 170 farthest from the skin according to steps S530 to S570 of FIG. 5, and accordingly provide, for instance, a frame of the touch indication regions 1501 and 1505 of FIG. 15A or the touch indication regions 1551 and 1555 of FIG. 15B to a specific display block in the flexible screen. Accordingly, the user can further remotely adjust the focus of the image capture apparatus 1205 via the touch indication regions 1501 and 1505 of FIG. 15A or the touch indication regions 1551 and 1555 of FIG. 15B.

It should be mentioned that, after the image capture apparatus 1205 receives a zoom-in focus adjustment signal or a zoom-out focus adjustment signal, the image capture apparatus 1205 can execute a focus adjustment function according to the focus adjustment signal. Moreover, if the zoom sensing module 1270 does not detect a zoom operation, then the processing unit 1290 does not send a focus adjustment signal via the communication unit 1250.

Moreover, in addition to remotely adjusting the focus of the external image capture apparatus 1205, the wearable apparatus 1200 of the invention can also include a zoom sensing module (such as a touch display), and determine whether a touch operation is received via the zoom sensing module, so as to perform image zoom operation. Referring to FIG. 15B, the zoom sensing module (such as a touch display) of a wearable apparatus 1550 of the present embodiment includes touch indication regions 1551 and 1555. When the touch indication regions 1551 and 1555 receive a sliding operation, the processing unit 1290 can also determine that an image zoom operation thereof is received and send an image zoom signal to the image capture apparatus 1205. The image capture apparatus 1205 can then perform corresponding image zoom adjustment on the image on the display unit thereof according to the image zoom signal to facilitate viewing of image details for the user.

It should be mentioned that, the wearable apparatus 1200 of an embodiment of the invention generates an effect of interactive control (such as focus adjustment, aperture adjustment, flash mode adjustment, or setting of countdown time for self-portrait) with a home audio and video product (such as a display or a television) or with an electronic apparatus having video/audio playback function disposed on a selfie stick (such as a selfie stick 1450 of FIG. 14), and is not particularly limited. Moreover, in other possible embodiments, the touch indication regions 1551 and 1555 may have different sizes, shapes, or positions, and can be modified according to design requirements.

In step S1350, the processing unit sends a shooting start signal via the communication unit 1250. When the image capture apparatus 1205 receives the shooting start signal, the image capture function is executed. For instance, the wearable apparatus 1400 of FIG. 14 sends a shooting start signal to the digital camera 1470 (or an electronic apparatus or smartphone having an image capture function), and then the digital camera 1470 begins image capture. Accordingly, the user can remotely control the shooting function and the focus adjustment function of the external image capture apparatus via the wearable apparatus in a simple manner, thus resulting in an added value to the wearable apparatus.

To facilitate understanding of the steps in the above embodiments, the interaction behavior between the wearable apparatus and the image capture apparatus of the embodiments of the invention are described below with examples.

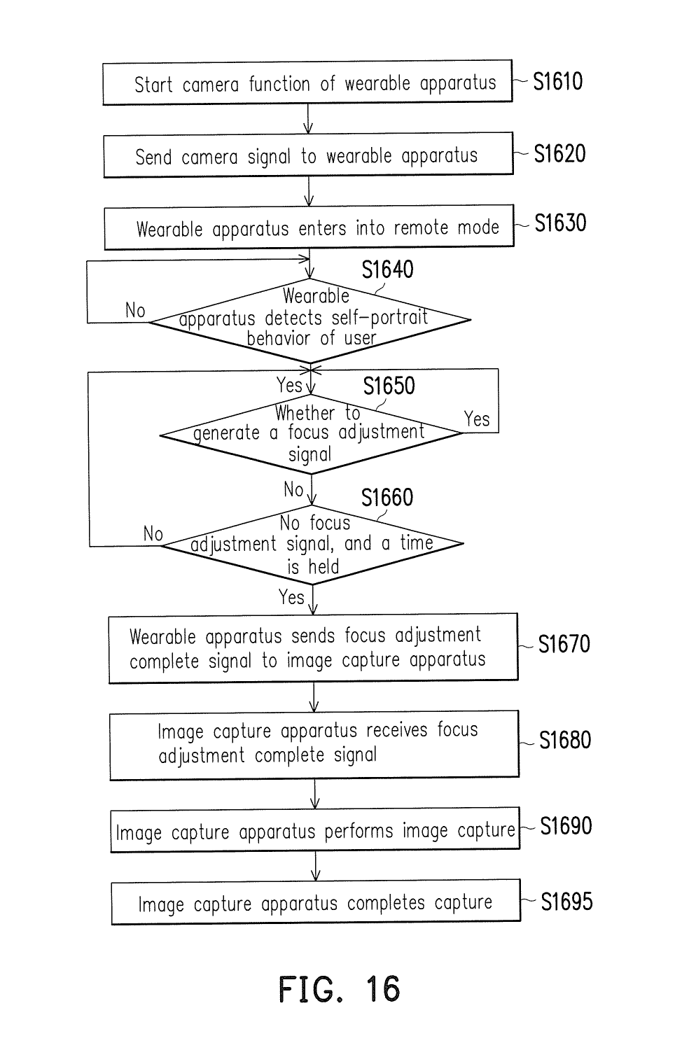

FIG. 16 is an example of the interaction between the wearable apparatus 1200 and the image capture apparatus 1205. Referring to FIG. 16, the image capture apparatus 1205 opens a camera function (step S1610). For instance, the image capture apparatus 1205 is turned on. During the startup process of the image capture apparatus 1205, the image capture apparatus 1205 establishes connection with the communication unit 1250 of the wearable apparatus 1200. In step S1620, the image capture apparatus 1205 sends a camera signal to the wearable apparatus 1200 via an established wireless channel. After the wearable apparatus 1200 receives the camera signal, the wearable apparatus 1200 enters a remote mode (step S1630). In step S1640, the wearable apparatus 1200 detects whether a self-portrait shooting of a user is in compliance with the shooting operation via the G-sensor 1210 (step S1640). If the wearable apparatus 1200 determines the user is performing a shooting operation, then the wearable apparatus 1200 determines whether to generate a focus adjustment signal (step S1605). If the wearable apparatus 1200 detects a zoom operation via the focus adjustment signal 1270, then the wearable apparatus 1200 sends a focus adjustment signal via the communication unit 1250. On the other hand, if no focus adjustment signal is present for a period (such as 1 second) (step S1600), then the wearable apparatus 1200 sends a focus adjustment complete signal (i.e., shooting start signal) to the image capture apparatus 1205 (step S1670). In step S1680, the image capture apparatus 1205 receives the focus adjustment complete signal, begins image capture (step S1690), and finishes capture to complete shooting (step S1695).

It should be mentioned that, the wearable apparatus 1200 of an embodiment of the invention can also be applied in a selfie stick or a selfie frame (such as the selfie stick 1450 of FIG. 14). For instance, capacitive sensors or a pressure switch are disposed on a selfie stick or a selfie frame, and the selfie stick or the selfie frame can generate a corresponding focus adjustment signal via the change in capacitance value sensed by the capacitive sensors or the change in pressure sensed by the pressure switch.

Based on the above, in the wearable apparatus having a ring body and the display method thereof of an embodiment of the invention, the moving state of the wearable apparatus is determined via a G-sensor, the auxiliary sensor farthest from the human body or the auxiliary sensor adjacent to the inside of the wrist is determined via the auxiliary sensors, and the relative position to the human body is determined according to the auxiliary sensor to decide the display block on the flexible screen, so as to display a frame on the display block. Accordingly, the user can view the frame displayed on the wearable apparatus in a simple, rapid, and intuitive manner. Moreover, in the wearable apparatus having a ring body and a control method thereof of another embodiment of the invention, the moving state of the wearable apparatus is determined via a G-sensor, and a touch signal is emitted via the communication unit to remotely control the external electronic apparatus. Moreover, in the wearable apparatus having a ring body and a control method of another embodiment of the invention, a shooting trigger signal (such as a shooting start signal, zoom control signal, or image zoom signal) is generated by determining the moving state of the wearable apparatus, so as to provide a signal to control, for instance, the shooting function, focus adjustment, or image zoom function of a remote image capture apparatus. Accordingly, the user can remotely control an external electronic apparatus such as a smartphone, a tablet computer, or a digital camera via a wearable apparatus in a simple and convenient manner.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A wearable apparatus suitable to be worn on a human skin surface via physical contact, comprising:
a ring body, wherein the ring body is surrounded with a periphery of a human body and comprises:
a G-sensor for detecting a moving state of the wearable apparatus;
a plurality of auxiliary sensors respectively arranged and disposed on a first surface of the ring body facing the human body;
a flexible screen disposed on a second surface of the ring body facing away from the human body in a surrounding manner; and
a processing unit coupled to the G-sensor, the auxiliary sensors, and the flexible screen, wherein the processing unit detects the moving state of the wearable apparatus via the G-sensor, when the processing unit determines the moving state of the wearable apparatus as a view operation, the processing unit determines a relative position of each of the auxiliary sensors to the human body via each of the auxiliary sensors, decides a display block on the flexible screen according to the relative position of each of the auxiliary sensors to the human body, and displays a frame on the display block of the ring body.

2. The wearable apparatus of claim 1, wherein the processing unit decides one of the auxiliary sensors farthest from the human body as a reference sensor according to the relative position of each of the auxiliary sensors to the human body, and decides the display block on the flexible screen according to a position of the reference sensor.

3. The wearable apparatus of claim 2, wherein the auxiliary sensors comprise a plurality of infrared emitters and a plurality of corresponding infrared receivers, the infrared emitters respectively emit a plurality of infrared lights, the infrared receivers respectively receive the infrared lights reflected from the human body, the processing unit compares a receive time that each of the infrared receivers receives the infrared lights to decide the relative position of each of the auxiliary sensors to the human body, wherein the processing unit decides one of the infrared receivers having the longest receive time as the reference sensor.

4. The wearable apparatus of claim 2, wherein the auxiliary sensors comprise a plurality of light emitters and a plurality of corresponding light receivers, a ball channel is disposed between the light emitters and the light receivers arranged and disposed on the first surface of the ring body, a ball is disposed on the ball channel, and the light emitters respectively emit a plurality of light sources, the light receivers respectively receive the light sources, and the processing unit determines a degree of shielding of the ball sensed by the light receivers, so as to decide the relative position of each of the auxiliary sensors to the human body, wherein the processing unit decides one of the light receivers having the greatest degree of shielding as the reference sensor.

5. The wearable apparatus of claim 2, wherein the auxiliary sensors comprise a plurality of magneto-resistive sensors, a slide channel is disposed adjacent to the magneto-resistive sensors arranged and disposed on the first surface of the ring body, a magnetic device is disposed on the slide channel, and the processing unit compares a magnetic line of force sensed from the magnetic device by the magneto-resistive sensors, so as to decide the relative position of each of the auxiliary sensors to the human body, wherein the processing unit decides one of the magneto-resistive sensors of a preset direction of magnetic line of force as the reference sensor.

6. The wearable apparatus of claim 2, wherein the auxiliary sensors comprise a plurality of capacitive sensors, and the processing unit determines a sensing state sensed from the human body by the capacitive sensors, so as to decide the relative position of each of the auxiliary sensors to the human body, wherein the processing unit decides one of the capacitive sensors that does not sense as the reference sensor.

7. The wearable apparatus of claim 2, wherein the auxiliary sensors comprise a plurality of humidity sensors, and the processing unit determines a humidity sensed from the human body by the humidity sensors, so as to decide the relative position of each of the auxiliary sensors to the human body, wherein the processing unit decides one of the humidity sensors for which the sensed humidity is less than a preset humidity as the reference sensor.

8. The wearable apparatus of claim 2, wherein the auxiliary sensors comprise a plurality of conductor apparatuses, and each of the conductor apparatuses is bridged with the processing unit via a voltage loop, and the processing unit determines a change in impedance of the conductor apparatuses to decide the relative position of each of the auxiliary sensors to the human body, wherein the processing unit decides one of the conductor apparatuses without change in impedance as the reference sensor.

9. The wearable apparatus of claim 1, wherein the auxiliary sensors comprise a plurality of heartbeat sensors, and the processing unit compares an ECG signal sensed by each of the heartbeat sensors, so as to decide the relative position of each of the heartbeat sensors to a determination region of the human body, and the processing unit determines one of the heartbeat sensors having the strongest detected ECG signal as the reference sensor, so as to decide the display block on the flexible screen according to a position of the reference sensor.

10. The wearable apparatus of claim 1, wherein the processing unit decides an angle range of a reference sensor from one of the auxiliary sensors extended along the flexible screen according to the relative position of each of the auxiliary sensors to the human body, and a block for which the angle range corresponds to the flexible screen is used as the display block.

11. A display method of a wearable apparatus suitable for a wearable apparatus having a ring body, wherein the ring body is surrounded with a periphery of a human body, and the display method comprises:
detecting a moving state of the wearable apparatus via a G-sensor;
determining a relative position of each of the auxiliary sensors to the human body via a plurality of auxiliary sensors when the moving state of the wearable apparatus is determined to be a view operation, wherein the auxiliary sensors are respectively arranged and disposed on a first surface of the ring body facing the human body;
deciding a display block on the flexible screen of the wearable apparatus according to the relative position of each of the auxiliary sensors to the human body, wherein the flexible screen is disposed on a second surface of the ring body facing away from the human body in a surrounding manner; and
displaying a frame on the display block of the ring body.

12. The method of claim 11, wherein the step of deciding the display block on the flexible screen of the wearable apparatus according to the relative position of each of the auxiliary sensors to the human body comprises:
deciding a reference sensor from one of the auxiliary sensors farthest from the human body according to the relative position of each of the auxiliary sensors to the human body; and
deciding the display block according to a position of the reference sensor.

13. The method of claim 12, wherein the auxiliary sensors comprise a plurality of infrared emitters and a plurality of corresponding infrared receivers, and the step of determining the relative position of each of the auxiliary sensors to the human body via the auxiliary sensors comprises:
emitting a plurality of infrared lights respectively via the infrared emitters;
receiving the infrared lights reflected from the human body respectively via the infrared receivers; and
comparing a receive time that each of the infrared receivers receives the infrared lights to decide the relative position of each of the auxiliary sensors to the human body, wherein one of the infrared receivers having the longest receive time is decided as the reference sensor.

14. The method of claim 12, wherein the auxiliary sensors comprise a plurality of light emitters and a plurality of corresponding light receivers, a ball channel is disposed between the light emitters and the light receivers arranged on the first surface of the ring body, a ball is disposed on the ball channel, and the step of determining the relative position of each of the auxiliary sensors to the human body via the auxiliary sensors comprises:
emitting a plurality of light sources respectively via the light emitters;
receiving the light sources respectively via the light receivers; and
determining a degree of shielding of the ball sensed by the light receivers, so as to decide the relative position of each of the auxiliary sensors to the human body, wherein one of the light receivers having the greatest degree of shielding is decided as the reference sensor.

15. The method of claim 12, wherein the auxiliary sensors comprise a plurality of magneto-resistive sensors, a slide channel is disposed adjacent to the magneto-resistive sensors arranged on the first surface of the ring body, a magnetic device is disposed on the slide channel, and the step of determining the relative position of each of the auxiliary sensors to the human body via the auxiliary sensors comprises:
comparing a magnetic line of force sensed from the magnetic device by the magneto-resistive sensors to decide the relative position of each of the auxiliary sensors to the human body, wherein one of the magneto-resistive sensors of a preset direction of magnetic line of force is decided as the reference sensor.

16. The method of claim 12, wherein the auxiliary sensors comprise a plurality of capacitive sensors, and the step of determining the relative position of each of the auxiliary sensors to the human body via the auxiliary sensors comprises:
determining a sensing state sensed from the human body by the capacitive sensors to decide the relative position of each of the auxiliary sensors to the human body, wherein one of the capacitive sensors that does not sense is decided as the reference sensor.

17. The method of claim 12, wherein the auxiliary sensors comprise a plurality of humidity sensors, and the step of determining the relative position of each of the auxiliary sensors to the human body via the auxiliary sensors comprises:
determining a humidity sensed from the human body by the humidity sensors to decide the relative position of each of the auxiliary sensors to the human body, wherein one of the humidity sensors for which the sensed humidity is less than a preset humidity is decided as the reference sensor.

18. The method of claim 12, wherein the auxiliary sensors comprise a plurality of conductor apparatuses, each of the conductor apparatuses is coupled to a voltage loop, and the step of determining the relative position of each of the auxiliary sensors to the human body via the auxiliary sensors comprises:
determining a change in impedance of the conductor apparatuses to decide the relative position of each of the auxiliary sensors to the human body, wherein one of the conductor apparatuses without change in impedance is decided as the reference sensor.

19. The method of claim 11, wherein the auxiliary sensors comprise a plurality of heartbeat sensors, and the step of determining the relative position of each of the auxiliary sensors to the human body via the auxiliary sensors comprises:
comparing an ECG signal detected by the heartbeat sensors to decide the relative position of each of the heartbeat sensors to a determination region of the human body, wherein one of the heartbeat sensors having the strongest detected ECG signal is determined as the reference sensor.

20. The method of claim 11, wherein the step of deciding the display block on the flexible screen of the wearable apparatus according to the relative position of each of the auxiliary sensors to the human body comprises:
deciding an angle range of a reference sensor from one of the auxiliary sensors extended along the flexible screen according to the relative position of each of the auxiliary sensors to the human body; and
using a block for which the angle range corresponds to the flexible screen as the display block.

21. A wearable apparatus, comprising:
a ring body, wherein the ring body is surrounded with a periphery of a human body and comprises:
a G-sensor for detecting a moving state of the wearable apparatus;
a communication unit for sending and receiving a wireless signal;
a zoom sensing module for detecting a zoom operation; and
a processing unit coupled to the G-sensor and the communication unit, wherein the processing unit detects the moving state of the wearable apparatus via the G-sensor, and when the processing unit determines the moving state of the wearable apparatus as a shooting operation, whether the zoom operation is detected by the zoom sensing module is determined to decide whether to generate a focus adjustment signal, and a shooting start signal is sent via the communication unit.

22. The wearable apparatus of claim 21, wherein the processing unit determines whether a component angle detected by the G-sensor is greater than a preset directional value, and determines a change in the component angle detected by the G-sensor within a determination time to decide the moving state is in compliance with the shooting operation.

23. The wearable apparatus of claim 21, wherein after the communication unit receives a camera signal, the processing unit detects the moving state of the wearable apparatus via the G-sensor.

24. The wearable apparatus of claim 21, wherein the zoom sensing module comprises a plurality of infrared emitters and a plurality of corresponding infrared receivers, the infrared emitters and the infrared receivers are respectively arranged and disposed on a first surface of the ring body facing the human body, the processing unit determines a receive time that the infrared receivers receive an infrared light emitted by the corresponding infrared emitters, so as to decide a distance between each of the infrared emitters or each of the infrared receivers and the human body, and decides the focus adjustment signal according to the distance between each of the infrared emitters or each of the infrared receivers and the human body.

25. The wearable apparatus of claim 21, wherein the zoom sensing module comprises a capacitive sensor, and the processing unit senses a capacitance value of the zoom operation according to the capacitive sensor to decide the focus adjustment signal.

26. The wearable apparatus of claim 21, wherein the zoom sensing module comprises a pressure switch, and the processing unit decides the focus adjustment signal according to a change in pressure of the zoom operation sensed by the pressure switch.

27. The wearable apparatus of claim 21, wherein the zoom sensing module comprises a touch display for generating a zoom control screen on a touch display region, the touch display is disposed on a second surface of the ring body facing away from the human body, the touch display comprises a touch indication region, and the processing unit decides the focus adjustment signal according to the zoom operation received in the touch indication region.

28. A control method of a wearable apparatus suitable for a wearable apparatus having a ring body, wherein the ring body is surrounded around a periphery of a human body, and the control method comprises:
detecting a moving state of the wearable apparatus via a G-sensor;
determining whether a zoom operation is detected via a zoom sensing module when the moving state of the wearable apparatus is determined as a shooting operation, so as to decide whether to generate a focus adjustment signal; and
sending a shooting start signal via a communication unit.

29. The method of claim 28, wherein the step of detecting the moving state of the wearable apparatus via the G-sensor comprises:
determining whether a component angle detected by the G-sensor is greater than a preset directional value, and determining a change in the component angle detected by the G-sensor within a determination time to decide the moving state is in compliance with the shooting operation.

30. The method of claim 28, further comprising, before the step of detecting the moving state of the wearable apparatus via the G-sensor:
receiving a camera signal via the communication unit.

31. The method of claim 28, wherein the zoom sensing module comprises a plurality of infrared emitters and a plurality of corresponding infrared receivers, the infrared emitters and the infrared receivers are respectively arranged and disposed on the first surface of the ring body facing the human body, and the step of determining whether the zoom operation is detected via the zoom sensing module to decide whether to generate the focus adjustment signal comprises:
determining a receive time that the infrared receivers receive an infrared light emitted by the corresponding infrared emitters;
deciding a distance between each of the infrared emitters or each of the infrared receivers and the human body; and
deciding the focus adjustment signal according to the distance between each of the infrared emitters or each of the infrared receivers and the human body.

32. The method of claim 28, wherein the zoom sensing module comprises a capacitive sensor, and the step of determining whether the zoom operation is detected via the zoom sensing module to decide whether to generate the focus adjustment signal comprises:
deciding the focus adjustment signal according to a change in capacitance value of the zoom operation sensed by the capacitive sensor.

33. The method of claim 28, wherein the zoom sensing module comprises a pressure switch, and the step of determining whether the zoom operation is detected via the zoom sensing module to decide whether to generate the focus adjustment signal comprises:
deciding the focus adjustment signal according to a change in pressure of the zoom operation sensed by the pressure switch.

34. The method of claim 28, wherein the zoom sensing module comprises a touch display for generating a zoom control screen on a touch display region, the touch display comprises a touch indication region, and the step of determining whether the zoom operation is detected via the zoom sensing module to decide whether to generate the focus adjustment signal comprises:
deciding the focus adjustment signal according to the zoom operation received in the touch indication region.
